(19) United States
(12) Patent Application Publication
(10) Pub. No.: US 2009/0157957 A1
(43) Pub. Date: Jun. 18, 2009

(54) APPARATUS WITH DISC DRIVE THAT USES CACHE MANAGEMENT POLICY TO REDUCE POWER CONSUMPTION

(75) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 11/568,189

(22) PCT Filed: Apr. 19, 2005
(86) PCT No.: PCT/IB05/51262

§ 371 Date: Oct. 23, 2006

(30) Foreign Application Priority Data
Apr. 27, 2004 (EP) 04101765.8

(51) Int. Cl. G06F 12/00

(52) U.S. Cl. 711/113; 711/E12.001; 711/E12.019

(57) ABSTRACT

Data blocks are loaded in multi-block fetch units from a disc. Cache management policy is selects data blocks for non-retention in cache memory so as to reduce the number of fetch units that must be fetched. Use is made of the large multi-block fetch unit size to profit from the possibility to load additional blocks essentially without additional power consumption when a fetch unit has to be fetched to obtain a block. Selection of data blocks for non-retention is biased toward combinations of data blocks that can be fetched together for a next use in one fetch unit. Between fetching of fetch units the disc drive is switched from a read mode to a power saving mode, wherein at least part of the disc drive is deactivated, so that energy consumption is reduced. Retention is managed at a granularity of data blocks, that is, below the level of the fetch units. If a combination of blocks from the same fetch unit can be fetched together at one go before their next use, these blocks are not retained if as a result other blocks, from a plurality of other fetch units, can be retained in place of the combination of blocks.

The invention relates to an information processing apparatus with a disc drive, and in particular to the reduction of power consumption by such an apparatus.

In modern electronic equipment, and in particular in battery operated equipment, low energy consumption is an important design aspect. In equipment with disc drives energy consumption can be reduced by deactivating parts of the disc drive, such as the motor and the laser in the case of an optical disc drive, for example by cutting of all or substantially all power supply current to these parts. When the disc drive has to handle a read request, e.g. due to the execution of a computer program, the relevant parts of the disc drive are temporarily activated until the data has been read into a memory. Once the information is stored in the memory the mentioned parts of the disc drive are deactivated, the program executing using the information from memory. Many application programs require so much data that the information cannot all be loaded beforehand in a memory of practical size. In this case, the reading elements of the disc drive are activated repeatedly during execution in order to load additional data, as needed for execution of the computer code.

Caching techniques may be used in order to minimize the number of times that specific data has to be read from the disc. If the total amount of processed data is larger than the cache memory size, cache management is needed, which involves selection of data blocks to be discarded from the cache (overwritten by other data). Various cache management policies are known that select such a discardable data block, the most well known being the LRU (Least Recently Used) policy, which involves discarding the least recently used memory block when memory space is needed for another data block.

More advanced cache management policies use a profile to predict the data blocks that will be used during execution of a program. Profiling, i.e. the establishment of a profile, involves recording which data blocks are used and in which sequence the data blocks are used during execution of the program, and computing statistical data from repeated executions of the program. In such a profile based cache management policy the discardable data blocks are selected so as to minimize the probability of cache misses, i.e. instances during execution of the program when a data block is not in cache when needed by the program. Typically, a data block is discarded from memory if it is predicted from the profile that the data block will not be reused, or, if all data blocks in the memory are predicted to be reused, a data block that is predicted to be used last is discarded, because it leaves most room over time. Thus the number times a data block has to be fetched from disc is minimized.

Some disc drives, in particular some optical disc drives, are arranged to read data in large units at a time. Typically, data is read in so-called fragments. A fragment contains a large predetermined number of data blocks that are located contiguously on disc, in 2 Megabyte per fragment for example. The seek overhead per byte is reduced by reading a large fragment, once the head is positioned properly. The architecture of optical disc drives, for example, makes head seek operations very expensive in terms of time used. The use of large fragments also reduces power consumption at the start of the execution of a program, because the duration of time that the disc drive needs to operate at peak power is reduced. However, the fetching during execution of a program of fragments with predetermined size is regarded as inefficient if a fragment contains much more data than is actually needed.

Among others, it is an object of the invention to reduce energy consumption during execution of a program in an apparatus with a disc drive.

The apparatus according to the invention is set forth in claim 1. According to the invention a cache management policy is used that selects data blocks that will not be retained in cache memory so as to reduce the number of fetch units that must be fetched. Use is made of the large multi-block fetch unit size (the minimum number of data blocks that is fetched at one time from the disc) to profit from the possibility to load additional blocks essentially without additional power consumption when a fetch unit has to be fetched to obtain a block. Selection of data blocks for non-retention is biased toward combinations of data blocks that can be fetched together for a next use in one fetch unit. Between fetching of fetch units the disc drive is switched from a read mode to a power saving mode, wherein at least part of the disc drive is deactivated, so that energy consumption is reduced. Not retaining a data block, as used herein, covers both overwriting the data block in the cache memory and not writing the data block to cache memory in the first place. Selected data blocks are not retained in the cache memory to make place for other data blocks.

Retention is managed at a granularity of data blocks, that is, below the level of the fetch units. Thus some data blocks of a fetch unit may be retained while other data blocks from the same fetch unit are selected not to be retained, dependent on a predicted need for these blocks. According to the invention the data blocks selected for non-retention are selected so as to reduce the number of fetch units that must be fetched. If a combination of blocks from the same fetch unit can be fetched together in one go before their next use, these blocks are not retained if as a result other blocks, from a plurality of other fetch units, can be retained in place of the combination of blocks. To realize this, the cache management unit makes use of a prediction when data blocks will be used. When selecting a particular data block that will not be retained the cache management unit takes account of whether other data blocks from the same fetch unit as the particular data block are in the cache memory and when these other data blocks are expected to be used.

In one embodiment a first data block is not retained if it is detected that a second data block from the same fetch unit is not in the cache memory and it is expected that the second data block will be needed before the first data block is needed next. In this case it can be predicted that not retaining the first data block will not cause an additional fetch of a fetch unit so that power can be saved by discarding the first data block rather than another data block from another fetch unit that would have to be fetched if the other data block is not retained.

In another embodiment a group of data blocks from the same fetch unit is selected not to be retained if it is predicted that the data blocks from the group will not be needed in a future time interval in which other data blocks from other fetch units are needed. The larger the group, the more space is created in the cache memory for caching those other data blocks, at the expense of fetching only one fetch unit to retrieve the group of data blocks. It may be noted that after the group has been selected, all data units from the group need not be discarded immediately. Some may be needed before the future time interval an need only be discarded once they are expected to be used last before the time interval, however once a first data block from the group has been discarded the circuit is committed to fetching the fetch unit again, so that the other data blocks from the group can then be discarded without power consumption penalty if the are expected to be needed only after the future time interval.

In an embodiment the cache management unit maintains information about the time that the fetch units of the data blocks in cache memory are expected to be fetched again. This information can be updated for example each time when a data block from the fetch unit has been discarded, if the expected time that the discarded data block is used again is before the previously expected time of fetching of the fetch unit. This type of timing information may be stored for every cached data block, or for every fetch unit from which data blocks are in cache. At the time of selection of a data block for discarding this information may be compared with the next expected time of reuse of the data block and if that next expected time is later that the expected time of fetching of the fetch unit that contains the data block, the data block may be discarded without incurring a power consumption penalty.

In an embodiment a cache management unit makes a prediction of data blocks that will be needed later during execution of the program and copies selected further data blocks from the fetch unit to the cache memory for retaining these blocks if these further data blocks have been predicted to be needed later. In this case data blocks that are not selected to be retained are not stored in the cache at all. Intermediate data blocks that are not predicted to be used need not be copied, because the selection that is copied need not be limited to contiguous data blocks. In this way the number of times the disc drive needs to be switched from the power saving mode is minimized, thereby minimizing power consumption.

In an embodiment the cache management unit detects, when selecting a discardable data block from cached data blocks that are predicted to be needed later, whether at least one of the cached data blocks is stored on disc in a same fetch unit as a further data block that is predicted to be needed from disc before the at least one of the data blocks, and if so, to give preference to discarding the at least one of the data blocks. Thus, more room is made available for keeping data blocks in cache, without increasing power consumption.

Preferably, the prediction is based on profile information that is obtained from actual execution of the computer program that causes the read operations in the apparatus. Thus a more reliable prediction is obtained, which minimizes power consumption.

In a further embodiment at least one of the blocks on the disc is relocated, upon detection that a first one of the fetch units has been fetched to obtain a first data block followed by a second one of the fragments to obtain a second block. In this case the blocks are rearranged automatically on the disc so that the first and second data block are stored in a common fragment on the disc. In this way the number of times the disc drive needs to be switched from the power saving mode is minimized.

These and other objects and advantages of the invention will be described in the description of an embodiment of the invention, using the following figures.

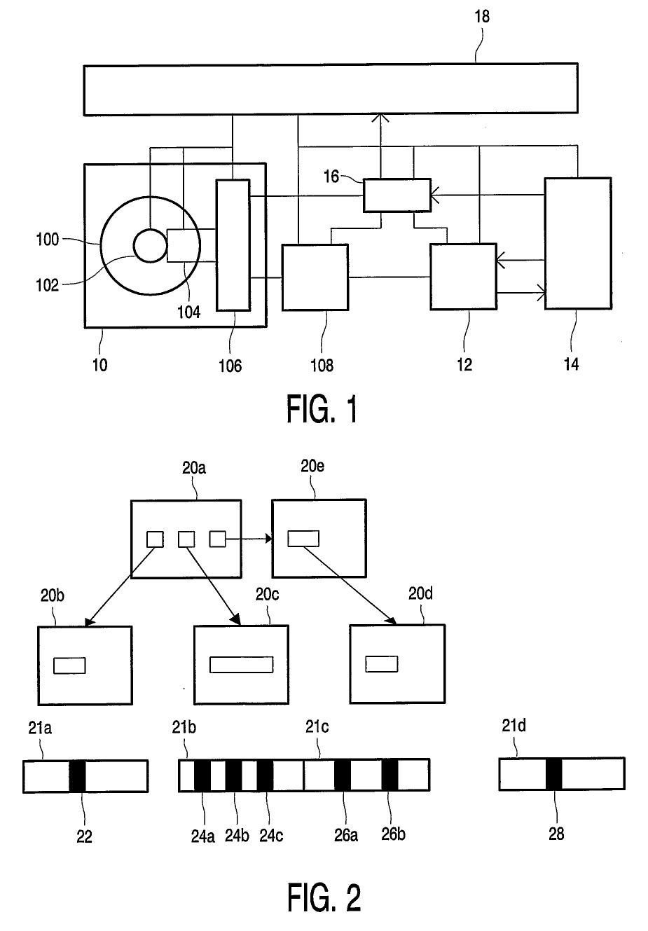

FIG. 1 shows a data processing apparatus;

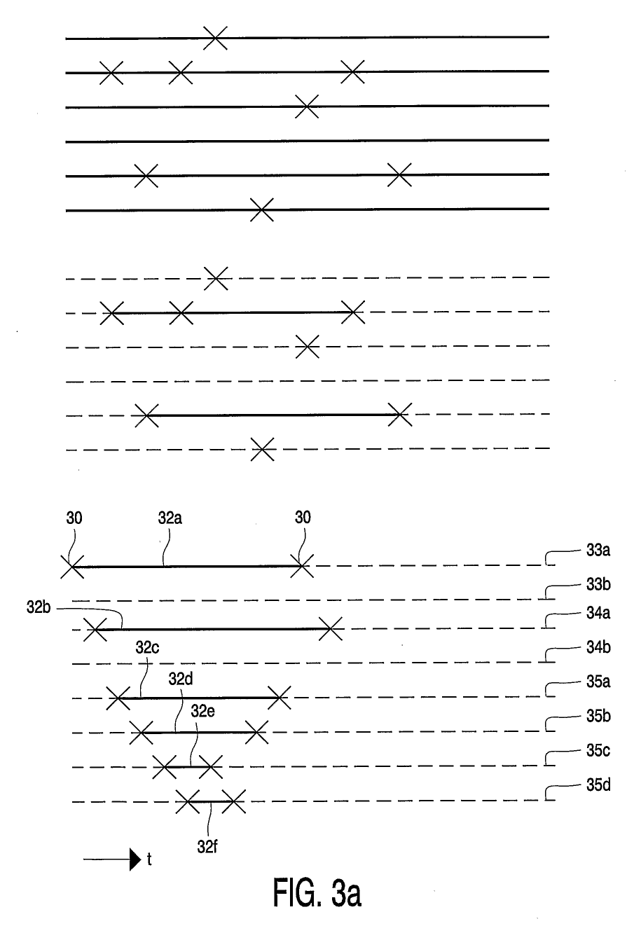

FIG. 2 shows an application program and a disc layout;

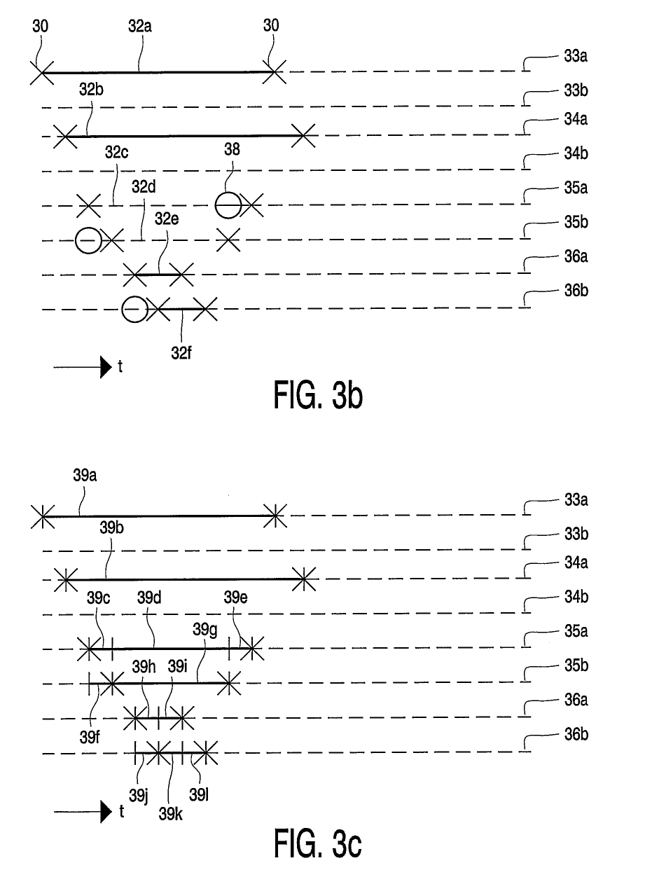

FIGS. 3a-c illustrate operation of a cache planning algorithm;

FIG. 1 shows a data processing apparatus. The apparatus contains a disc drive 10, a cache memory 12, a processor 14, cache management unit 16 and a power supply circuit 18. Disc drive 10 contains a disc 100 (for example an exchangeable optical disc), a motor 102, a read head 104 and control electronics 106. In addition a disc buffer memory 108 is provided. Cache management unit 16 is coupled to a control input of the control electronics 106. A data output of disc drive 10 is coupled to an input of disc buffer memory 108, which is coupled to cache memory 12, which in turn is coupled to processor 14 via an address/data bus. Cache management unit 16 has a control output coupled to disc buffer memory 108, cache memory 12 and to power supply circuit 18.

Power supply circuit 18 has a first output coupled to disc buffer memory 108, cache management unit 16, cache memory 12 and processor 14, and a second output coupled to motor 102, read head 104 and control electronics 106 of disc drive 10.

In operation processor 14 executes an application program that requires data from disc 100. Disc drive 10 loads data from disc 100 into disc buffer memory a fragment at a time. A fragment contains data that is stored substantially contiguously on disc, for example along a spiral data track on disc (by “substantially” it is meant that management information, such as synchronization data, header data etc. may also be present). The size of a fragment is much longer than the length of data blocks needed by processor 14, for example 2 Megabytes of data.

In the embodiment of FIG. 1 cache management unit 16 controls fetching of data. When cache management unit 16 detects or predicts that a certain data block will be needed during execution of the application program and that this data block is not present in cache memory 12, cache management unit 16 signals to power supply circuit 18 to activate the power supply to disc drive 10, and in particular to motor 102, read head 104 and electronics 106. Cache management unit 16 then commands disc drive 10 to fetch the fragment that contains the data block, whereupon disc drive 10 loads the fragment and stores it in disc buffer memory 108. After the fragment has been read cache management unit 16 signals to power supply circuit to cut the power supply to disc drive 10.

In the embodiment of FIG. 1 cache management unit 16 causes required data from the fragment in disc buffer memory 108 to be copied into cache memory 12. When not all of the data is needed, cache management unit 16 does not cause all of the data from the fragment to be copied. The unit of cache management is called a data block, which is much smaller than a fragment, say 32 Kilobyte. Cache management unit 16 is arranged to maintain identification of data in the cache per cache block, so that data blocks as a whole will be loaded into cache and discarded from cache. Cache management unit 16 copies only the data blocks which contain data that is expected to be needed for execution by processor 14.

In another embodiment processor 14 is able to access part of the data blocks directly from disc buffer memory 108. In this embodiment cache management unit 16 copies a data block from disc buffer memory 108 only if it is expected that the data block will be needed later during execution of the application program, when the fragment has been overwritten in disc buffer memory 108 by a later loaded fragment. Similar embodiments may include further buffer memories for fragments, from which data is copied to cache memory 12 to prevent it from being overwritten.

Cache memory 12 is used to reduce the number of times that disc drive 10 needs to be activated to reload the same fragment. Typically the size of cache memory 12 is insufficient to store at any one time all data from disc 100 that is used by processor 14 during execution of the application program (or, in the embodiment where processor 14 accesses a fragment buffer memory, than the entire volume of data that is used after it has been overwritten in the buffer memory). This means that, in order to make room, data in cache memory 12 will have to be overwritten by data that is needed later, with the effect that disc drive 10 may have to be activated to load the overwritten data again.

To minimize the number of times the disc drive 10 needs to be activated, cache management unit 16 first of all limits the data blocks that are copied into cache memory 12 to selected data blocks from the fragment that are expected to be used. Secondly, cache management unit 16 selects the locations where data blocks will be overwritten, so as to minimize overwriting of data blocks that will later be needed at the expense of loading an additional fragment.

When processor 14 needs a data block that is not stored in cache memory, cache management unit 16 causes the data block to be loaded from disc 100. With the data block an entire fragment is loaded. Cache management unit 16 determines whether there are any additional data blocks in this fragment that are expected to be needed later during execution of the application program. If so, cache management unit 16 causes these additional data blocks to be copied into cache memory 12. Thus, use is made of the fact that data blocks will be loaded as a side effect of loading other data blocks, due the large fragment size provided by disc drive 10.

The fact that data blocks will be loaded into cache memory due to side effects is used to guide selection of data blocks that can be overwritten. When cache management unit 16 predicts that a data block will be loaded as a side effect before later use, cache management unit 16 discards this data block from cache memory 12, if necessary to create room for later data blocks.

FIG. 2 schematically shows an application program and the data blocks used by this program. The program comprises file modules 20a-e, that need data from disc 100. The data has needed by modules 20a-e been symbolically indicated as blocks within the modules 20a-e. The figure also shows a number of fragments 21a-d from disc 100 in which the data used by the modules is stored, and within the fragments 21a-d different clusters of data 22, 24a-c, 26a,b, 28 used by modules 20a-e are indicated.

In operation, the sequence in which modules 20a-e are active depends on external factors, such as user input. Operation will be illustrated using the following table, for the simplified example that cache memory 12 has capacity for three data blocks.

| block | | | | |
|---|---|---|---|---|
| needed | fragment | cache block 1 | cache block 2 | cache block 3 |
| 24a | 21b | 24a | 24b | 24c |
| 26a | 21c | 24a | 26a | 26b |
| 24a | — | 24a | 26a | 26b |
| 22 | 21a | 22 | 26a | 26b |
| 26b | — | 22 | 26a | 26b |
| 24b | 21b | 24a | 26a | 24b |
| 24a | — | 24a | 26a | 24b |
| 26a | — | 24a | 26a | 24b |

The first column shows the data blocks that are needed for execution of the program. Successive rows show successively needed data blocks. The second column shows the fragments that cache management unit 16 causes disc drive 10 to load, if any, to obtain the data blocks of the first columns. The following columns show the data blocks that are in cache memory 12 after loading the fragment, if any.

As can be seen, in some of the rows no fragment needs to be loaded, when the relevant data block is already in cache memory 12. Disc access power consumption is avoided each time when no fragment needs to be loaded. Attention should be paid to the row in which block 22 is loaded. Here cache management unit 16 decides to discard block 24a from cache memory 12, even though this block will be needed before block 26b that is also in cache memory 12, because block 24a will be loaded as a side effect of loading block 24b before block 24a is needed again.

In order to determine which data blocks have to be copied to or retained in cache memory 12, cache management unit 16 uses a prediction of the data blocks that will be needed by processor 14 during execution of the application program. When the application program always needs the blocks in the same order, cache management unit 16 realizes prediction by means of a profile that represents the order of access to the data blocks during execution of the program (effectively recording the leftmost column of the table). This profile may be provided with the program, or recorded during a first execution of the program. During subsequent executions the recorded order is used to predict when the data blocks will be needed.

Cache management unit 16 can use any one of a number of algorithms for the selection of the blocks that may be discarded because a data block will be loaded as a side effect before later use. In one embodiment, cache management unit 16 searches for a caching plan that minimizes energy consumption for fragment fetches according to the profile. The search may be performed at run-time, during execution of the program, or before execution of a program. In another embodiment, cache management unit 16 merely applies selection rules for selecting data blocks that will be discarded, where the selection rules take account of the fact that data blocks can be fetched together as part of a fragment with little overhead.

FIGS. 3a,b are used to illustrate the operation of selection algorithms. Horizontal lines 33a,b, 34a,b, 35a,b, 36a,b each represent a data block. Fragments correspond to successive pairs of lines 33a,b, 34a,b, 35a,b, 36a,b. Time “t” during program execution is represented from left to right. Crosses 30 on the lines (only exemplary crosses labelled with a reference number) represent the time points of use of data from the data blocks (successive use that is not interrupted by use of other data blocks is indicated by a single cross). Data blocks that are not used more than once have been omitted from the figure, since they do not affect cache memory.

Some data blocks are shown to be used more than once at different times points, making it attractive to retain these data blocks in came memory 12 in between. This is expressed in FIG. 3a by drawing the time intervals between the different time points at which data from the same data block is used as solid line segments 32a-f.

A potential cache conflict exists if more data blocks would have to be retained than there is storage capacity in cache memory 12. There is a potential cache conflict for those time points for which the number of overlapping solid line segments 32a-f exceeds the cache capacity. Cache planning involves decisions to discard data from cache memory 12, i.e. selecting line segments 32a-f during which respective data block are not retained in cache, although needed later.

Assuming for example that the cache has capacity for four blocks, it can be seen that a conflict exists from the start of interval 32e. According to a conventional “least recently used” cache management algorithm, the block corresponding to line 33a would now be discarded, followed by the block corresponding to line 34a at the start of interval 32f. As a result two fragments (corresponding to the pairs of lines 33a,b and 34a,b respectively) would have to be refetched as the price of discarding. A similar result would be obtained with an algorithm that discards the data blocks which will be used last: in this case the blocks corresponding to lines 33a, 34a will be discarded as well.

FIG. 3b show what happens when cache memory unit 16 takes account of the fact that multiple data blocks will be fetched at no extra cost if they are part of the same fragment. Another discarding selection is made, discarding the datablocks corresponding to lines 35a,b. As a result the data block corresponding to line 35a will return to cache memory 12 when the data block is corresponding to line 35b is fetched, as indicated by circuit 38. During intervals 32c,d these data blocks are not needed in cache memory, as indicated by dashing the lines that represent these intervals. As a result there is sufficient room in cache memory 12 for the data blocks corresponding to lines 36a,b: the data blocks corresponding to lines 33a, 34a need not be discarded. Only a single refetch is needed, for the data blocks corresponding to lines 35a,b, because these are in the same fragment. Further circles indicate when data blocks are initially loaded into cache memory 12 together with another data block from the same fragment.

Cache management unit 16 may use a search algorithm to select the data blocks to be discarded. This algorithm involves minimization of a cost function, which equals the total number of blocks that has to be fetched, under the constraint that cache capacity is not exceeded. The algorithm searches for blocks whose cache memory location may be reused during certain time intervals. The time intervals that the search algorithm select run from one time point where a block is used to a next time point where the block is used again. That is, the time intervals are the time intervals 32a-f. When the search algorithm has selected not to retain a block in cache memory during a time interval 32a-f, that time interval is said to be “inactive”. The other time intervals are said to be active. More formally therefore, the search algorithm searches for a set of inactive time intervals so that the number of active time intervals at any one time point does not exceed cache capacity, so that the number of inactive time intervals is minimal.

Search algorithms for searching for solutions that optimize a criterion under constraints are known per se, both in the form of searches that are guaranteed to find an optimal solution and in the form of approximate searches that are merely likely to find a good solution. Any such technique may be used. According to the invention such search algorithm may applied to search for blocks to discard so as to minimize the cost function, which equals the total number of blocks that has to be fetched, under the constraint that cache capacity is not exceeded.

An embodiment of such a search algorithm selects the time intervals as bundles. When a time interval for a particular data block that ends at a certain time point is selected to become inactive, the time intervals for other blocks in the same fragment that cover the time point are split at that time point. The parts of those time intervals that run up to the time point is selected to be inactive as well. This accounts for the fact that, when the particular block is loaded at a time point the other blocks will be loaded as well, so that they need no be kept in cache memory in the time intervals between the time point and their last previous use (or their initial loading).

FIG. 3c illustrates selection of bundles of intervals. The intervals 32a-f have been split at those time points where data from other data blocks from the same fragment is used (i.e. it splits interval 32c at the start and end of interval 32d). For each particular data block additional intervals are added from the time points where data from other data blocks from the same fragment is used before the particular data block is first used.

A bundle has a one to one relation with a particular block and a time point where data from that block is used. The bundle includes all further intervals of blocks from the same fragment as the particular block that end at that time point, and extend from the last time point where the block corresponding to the further interval was last used previously. Examples of bundles are (39c, 39d, 39g), corresponding to the time point at the end of interval 39g where the block of line 35a is used, (39c, 39f) corresponding to the time point at the end of interval 39f, where the block of line 35b is used.

The algorithm searches for a set of bundles that contains a minimal number of bundles (and therefore involves a minimum number of block fetches) with the constraint that the number of remaining intervals when the bundles have been removed does not exceed cache capacity.

A simple algorithm builds a list of sets of bundles Si. Each set corresponds to a possibly incomplete solution of the search: a selection of bundles that will be discarded from cache memory. The algorithm starts from an empty set So (without any bundles), and builds new sets Si′ for the list by adding bundles to existing sets Si in the list (e.g. the empty set { } being expanded into a set {(39a)} with one bundle (39a), and again into a set {(39a),(39b)} with two bundles). Sets that satisfy the constraint that the number of remaining intervals when the bundles have been removed does not exceed cache capacity are called complete sets, other sets are called incomplete sets.

First one set is expanded each time by identifying the time point where the capacity is exceeded and adding a bundle that covers the time point to the set. Eventually, this will result in a complete set Sf (e.g. Sf={(39a), (39b)}. The number of bundles N(Sf) (e.g. 2) in this set Sf is computed (which is the number of fragments that has to be fetched).

Next other sets of bundles Si are added to the list by expanding the sets in the list, e.g. the sets {(39c, 39f)}, {(39d, 39g)} etc.). If such a set Si is also complete (e.g. if Si={(39c, 39d,39g)}, the number of bundles N(Si) in this set Si is compared with N(Sf) and if N(Si)<N(Sf) the set Si replaces Sf and all sets S′ in the list with N(S′)≧N(Si) are removed from the list. When the set Si is incomplete, N(Si) is computed and if N(Si)>N(Sf) the set Si is not further expanded. Otherwise the set Si is further expanded, until either N(Si)≧N(Sf), or Si is complete.

This type of algorithm is certain to find an optimal cache management policy. In principle the algorithm can be applied apriori, before the program is executed, or each time at a time point during execution, when cache space is needed. In the latter case, the list is preferably built by first adding sets to the list that each contain a bundles that is active at the particular time point.

For example, in the example of FIG. 3c, when cache memory 12 has capacity for four data blocks, a conflict first occurs at the start of time interval 39h. At this time point the following bundles are active: (39a), (39b), (39c, 39d, 39e), (39c, 39d, 39g), which correspond to decisions to reload a fragment at the end of time intervals 39a, 39b, 39e and 39g respectively. Sets containing each of these bundles are first added to the list. Next the sets are expanded. As is turns out the set Sf={(39c, 39d, 39e)} is already complete (corresponding to reloading at the end of interval 39e) and N(Sf)=1 so that it is an optimal solution so that the other sets need not be considered.

The selection of the bundles with which the sets are expanded can be guided to increase the efficiency of the search, for example by expanding the sets only with bundles that cover time points where the capacity of the cache is still exceeded. In case of FIG. 3 for example, if a first set contains only bundle (39a), and the cache has capacity for four data blocks, cache capacity is exceeded only during intervals 39j-1. In this case only bundles (39b), (39c,39d,39g), (39h, 39j), (39i,39k) and (39l) need to be added to set {(39a)}. Furthermore, the algorithm preferably first adds those bundles that contain the most intervals (i.e. bundles (39d,39g) (29h, 39j), (39i,39k)), and among those that covers the most time points where cache capacity is exceeded (e.g. (39d,39g)) since these will create most space in cache memory.

This can be implemented in a heuristic search algorithm where a ceiling function h(S) is defined for a set of bundles, which gives an upper limit for the number of bundles that have to be added to the set S to ensure that cache capacity is not exceeded at any time point. An example of a ceiling function h(S) is the sum of the number of data blocks by which cache capacity is exceeded once the data corresponding to the bundles from S has been discarded in the time intervals from the bundles, summed over the time points where the capacity is exceeded.

The heuristic algorithm each time expands that set S for which the ceiling function h(S) plus the number of bundles N(S) in the set is lowest. That is, when a set S can be expanded with different bundles, the expanded set where the additional bundle reduces h(S) most is further expanded. Starting from the empty set for example, it can be seen that adding the bundle (39c,39d,39g) gives the greatest reduction in h(S).

Those sets S′ in the list that contain a number of bundles N(S′) that is greater than or equal to the lowest h(S)+N(S)−1 for any set S in the list need not further be expanded in the search for the optimal set. Thus an optimal result is ensured. In addition, floor functions g(S′) may be used, which give the minimum number of bundles that must be added to a set S′ to construct a set that ensures that cache capacity is not exceeded (an example of a floor function is the maximum number of data blocks from different fragments by which cache capacity is exceeded at any one time if data blocks corresponding to the set S′ have been discarded in the time intervals corresponding to S′, i.e. the maximum number of excess bundles once S′ has been removed). If there is a set S so that h(S)+N(S)≦N(S′)+g(S′) the set S′ need not be further expanded.

This type of search, too, may be applied prior to execution or during execution. If applied during execution, the algorithm preferably selects bundles that cover time points where a cache excess occurs, starting from the current time point during execution and adding bundles each time for the next time point where a cache excess occurs. If all sets solve the cache capacity problem up to a time point “t” are gather in the list, the ceiling function h(S) may adapted to give a ceiling for the maximum number of bundles needed to solve cache excess up to the last time point t′ that is covered by any of the bundles in the set on the list. As a result, the search will start to look for reusing cache memory locations for fragments from which there are many data blocks in cache, but it will check whether data blocks from other fragment that are not needed for a longer time cannot give a better solution.

As described up to this point the search using floor and/or ceiling functions is complete, in the sense that it will find a set of bundles that involves no more fragment refetching that any other set. This is an optimal solution, in the sense that no more power efficient solution is possible. However, without deviating from the invention a faster an incomplete search may be used, which finds a good selection of bundles but not necessarily optimal bundles.

For example, an incomplete search algorithm constructs only one final set S, by cumulatively adding each time that bundle that most reduces h(S). In the example of FIG. 3, the bundle (39c, 39d,39g) would be selected in this way. As was mentioned, an example of a ceiling function h(S) is the sum of the number of data blocks by which cache capacity is exceeded once the data corresponding to the bundles from S has been discarded in the time intervals from the bundles, summed over the time points where the capacity is exceeded. In this case one selects each time a next bundle by computing for each bundle how many of the excess data blocks it removes, summed over all time points where there is an excess, and selecting the bundle that yields the highest result. However, other criteria may be used in an incomplete search, such as expanding the set with the bundle that removes most data blocks at the time point where there is the greatest remaining excess over cache capacity (the greatest number of solid lines in FIG. 3c) etc.

Using this type of algorithm cache management unit 16 effectively selects a set of bundles that solves the cache conflict. This set will be called a caching plan. Cache management unit 16 proceeds according to the caching plan, by reusing any cache locations for the data blocks from the selected set of bundles in the time intervals corresponding to the bundles. That is, when cache management unit 16 has selected a bundle, this means that cache management unit 16 has accepted a refetch of the fragment at the time point at the end of the time intervals in the bundle. Subsequently the cache locations of any data block from that fragment that is not used before the scheduled time point may be reused. In case of a statistical profile, the average expected energy consumption (the average number of fragment fetches) may be minimized, as computed with the probabilities from the profile.

Cache management unit 16 may select the least consuming caching plan prior to execution of a program, or during execution well in advance of execution of parts of the plan. This makes it possible to make a thorough search. Alternatively, the plan may be made on the fly, each time before discarding a data block. This makes it possible to adapt the plan to actual program flow. In this case, the caching plan may be developed for part of program execution, e.g. for a time window from discarding the next block

During run time planning, only the selection of the bundle to be discarded at the current time point is relevant. For example, as a run time equivalent of the sub-optimal algorithm, cache management unit 16 at a time point considers the active bundles. For example cache management unit 16 considers respective data blocks that are in cache and will first be used again at a respective later time point, and for each such data block cache management unit identifies the other data blocks from the same fragment that are in cache memory 12 and that will not be used before the later time point. Then cache management unit 16 counts for each respective data block how much the cache excesses will be reduced, summed over time points up to the respective later time point. The respective data block that yields the highest count is selected. Cache management unit 16 then reuses the cache memory locations used for that respective data block and for any further data blocks from the same fragment that are not needed before the respective data block. Any of these locations may reused in any order, but preferably the location for the last needed data block is reused first.

However, other criteria may be used in a suboptimal search, such as discarding data blocks from the fragment so as to remove most data blocks at a future the time point before data from the fragment is needed again where there is the greatest remaining excess over cache capacity etc. More complicated selection algorithms may be used, which involve a greater amount of search for appropriate data blocks to be discarded starting from the current time point.

Preferably cache management unit 16 prefetches the data blocks before they are actually needed, to avoid delay when data blocks need to be fetched from disc. This may be realized for example by including prefetch commands in the program at the appropriate times. Prefetch timing may also be provided by storing the profile in association with a indication of the stage of progress of execution of the program where the blocks are needed, such as a cycle count since the start of program, or program counter values etc.

When the program does not always need the data blocks in the same order the profile is compiled from statistical data about executions. This kind of profiling is known per se. Basically, for each of a number of points during program execution it is recorded which sequence of data blocks will most likely be needed in future, preferably for each of a number of combinations of one or more most recently used blocks. Thus, cache management unit 16 can retrieve the predicted sequence in which the blocks will be needed dependent on the stage of processing and the actual combinations that have occurred.

If disc 100 is a rewriteable disc, the blocks may be rearranged on disc 100 to minimize the need to load fragments when a particular cache policy is used. An appropriate rearrangement can be selected on the basis of the profile. For example, if the profile shows that a first fragment is generally fetched first and that subsequently a second fragment is fetched to load a particular block, then the particular block may be moved to the first fragment to prevent the need to fetch the second block from the second fragment. Alternatively if the profile shows that only specific blocks from the first fragment are used, these specific blocks may be moved to the second fragment, or the specific blocks and the particular blocks may be moved to a third fragment.

Rearrangement is preferably performed automatically during use of a specific disc 100, e.g. under control of cache management unit 16, during or between executions of the program. Cache management unit 16 performs rearrangement depending on information from the profile and cache architecture. For example, cache management unit 16 selects rearrangement of the particular block and the specific blocks into the same fragment if the profile indicates the interval between loading the specific blocks and loading the particular block is so small that in the interval insufficient blocks will be needed to force replacement of the particular block from cache memory 12. Similarly, cache management unit 16 may select to distribute blocks from one fragment may over different fragments if the interval between use of blocks from the fragment is so long that blocks loaded as a side effect will be have to be replaced in cache memory 12 before they are used.

It should be appreciated that the invention is not limited to a particular cache management policy. In general the cache management policy is preferably selected dependent on the fetch properties of the disc drive.

For example, if there is a predetermined arrangement of fixed length fragments on disc, the disc drive 10 being able to fetch only fragments up to a predetermined length from predetermined starting points, then the decision to retain a particular block from a specific fragment in cache memory 12 depends on whether the profile indicates that other blocks from the specific fragment will have to be loaded before the particular block.

In another example, disc drive 10 is capable of fetching fragments of predetermined size (determined by buffer memory 108, for example), which each contain a data block at a particular location on disc, but start from different starting points. Thus different combinations of consecutive blocks occur in a fragment, dependent on the starting point (e.g. if blocks A,B,C,D,E,F are stored on disc and a fragment consists of four blocks, then, if disc drive 10 can start reading a fragment from block A or from block C, fragments (A,B,C,D) and (C,D,E,F) can be read, one containing a combination of blocks (e.g. D and E) that the other does not contain).

In this example, cache management unit 16, when fetching a particular data block has the additional freedom to select the starting point of the fragment for fetching this particular data block. Preferably, in order to make advantageous use of this freedom, cache management unit 16 determines from the profile whether there is an additional data block that (a) is not in cache memory 12, that (b) will be needed after the particular data block so soon that it can be kept in cache memory 12 until use and (c) is stored on disc 100 so close to the particular data block that the additional data block can be read together with the particular data block in a same fragment. If there is such a data block, cache management unit 16 selects the starting point of the fragment for fetching the particular data block so that the fragment contains the additional data block as well. Once fetched, the additional data block is kept in cache memory 12 for later use. Thus, an additional fragment fetch is prevented.

In another example, the length of the fragment can be varied as well. In this case, cache management unit 16 preferably also adapts the length of a fragment to reduce power consumption. When a particular data block has to be fetched, the fragment length is adapted so that the fragment also and preferably only just contains an additional data block or blocks that can be cached for later use according to the profile.

Although in the embodiments that have been described parts of the disc drive, such as the motor and the actuator are deactivated (disabled) by cutting power supply to these parts, it will be appreciated that power supply consumption of these parts can be reduced by deactivating these part in other ways, for example by using a control signal that switches the part to another lower power consumption mode, e.g. to a lower speed.

Furthermore, although the invention has been described for an apparatus that reads a fragment at a time, it will be understood that one may use other fetch units of a plurality of data blocks that can be fetched together with little or no energy consumption overhead. For example, instead of fixed size, fixed position fetch units, fixed size fetch units starting at variable positions on disc may be used, so that a particular data block may be loaded with a selectable context of other data blocks (e.g. with N−1 preceding data blocks (N being the size of the fetch unit), or N−1 following data blocks or with N−1−m preceding and m following data blocks. It should be appreciated that this does not affect the invention, since it merely requires searching for the most power saving starting points (defining additional possible bundles that may be selected). Similarly, if the size N of the fetch unit affect power consumption, the size may be adapted during the search.

1. An information processing apparatus, comprising:
a disc drive (10) arranged to read data from a disc (100), a fetch unit at a time, each fetch unit containing a plurality of data blocks that are stored substantially contiguously on the disc (100);
a processing circuit (14) for executing a program using the data blocks;
a cache memory (12) coupled to the disc drive for caching data blocks read from the disc (100) for use by the processing circuit (14) during execution of the program, the cache memory (12) having a replacement granularity of individual data blocks;
a cache management unit (16) arranged to select which data blocks from within the fetch units not to retain in the cache memory (12), dependent on a prediction of when which data block will be needed during execution of the program, the cache management unit (16) selecting not to retain at least a first data block in response to information about a cache status and expected time that a second data block in a same fetch unit as the first data block will be needed next, so that space in the cache memory (12) is freed by not retaining the first data block if it is predicted that the first data block will be fetched when the second data block is predicted to be fetched, before the next use of the first data block.

2. An information processing apparatus according to claim 1, wherein the cache management unit (16) is arranged to detect whether the second data block is not in the cache memory (12) and the first data block is expected to be needed next after the second data block is expected to be needed next and the cache management unit (16) allows overwriting of the first data block in the cache memory (12) in response to said detection.

3. An information processing apparatus according to claim 1, wherein the cache management unit (16) is arranged to detect whether the second data block is in the cache memory (12) and no use of the second data block is expected during a future time interval before a next expected use of the first data block, during which future time interval a further data block is expected to be used from outside said same fetch unit, where said further data block is in the cache memory (12) and/or is expected to be needed before the future time interval, and to allow overwriting of the first data block in response to said detection.

4. An information processing apparatus according to claim 1, wherein cache time intervals are defined for each respective data block, the cache time intervals running between predicted successive uses of the respective data blocks and/or between use and fetching of the respective data block as part of a fetch unit, the cache management unit (16) being arranged to search for a set of cache time intervals during which the cache management unit (16) plans to retain the respective data blocks associated with the cache time intervals, so as to minimize a predicted count of fetch operations from disc (100) under a constraint that a number of overlapping time intervals in the selected set at no time exceeds the number of data blocks that the cache memory can store simultaneously, the predicted count that is minimized counting each fetch operation for fetching a plurality of data blocks from the same fetch unit as one fetch operation.

5. An information processing apparatus according to claim 1, wherein the cache management unit (16) is arranged to maintain information indicative of an expected first next time that said same fetch unit is expected to be fetched for obtaining the second data block, and to allow overwriting of the first data block dependent on whether a next predicted use of the first data block is after that expected first next time.

6. An information processing apparatus according to claim 1, wherein the cache management unit (16) is arranged to control selective copying of selected data blocks from a fetched fetch unit into cache memory (12), so that the data blocks from the fetched fetch unit are copied to the cache memory (12) dependent on whether the selected data blocks have been predicted to be needed later during execution, so that only a selection of not necessarily contiguous data blocks is copied.

7. An information processing apparatus, according to claim 1, wherein the disc drive (10) is arranged to fetch units of a predetermined size, the fetch units being stored mutually non-overlapping on the disc.

8. An information processing apparatus, according to claim 1, wherein the disc drive (10) is arranged to fetch fetch units of a predetermined size from programmable starting points, so that different fetch units can be fetched from overlapping regions on the disc, the cache management unit (16) being arranged to select a starting point of the fetch unit for loading a particular data block dependent on a prediction whether a further data block in a vicinity of the particular data block will be needed after the particular data block, the starting point being adapted so that the further data block is included in the fetch unit.

9. An information processing apparatus according to claim 1, wherein the cache management unit (16) comprises a profiling component, arranged to record profile information about a sequence in which data blocks are during repeated executions of the program, the prediction being computed from the profile information.

10. An information processing apparatus according to claim 1, comprising a block relocation unit, arranged to relocate at least one of the blocks on the disc, the block relocation unit being arranged to detect when a first one of the fetch units has been fetched to obtain a first data block followed by a second one of the fetch units to obtain a second data block, and to rearrange the blocks on the disc so that the first and second data block are stored in a common fetch unit on the disc.

11. A method of processing data from a disc, the method comprising:
executing a program that uses data from data blocks that are stored on a disc (100);
fetching the data blocks from the disc (100) together in fetch units, each containing a plurality of data blocks that are stored substantially contiguously on the disc (100);
reducing energy consumption for reading data from the disc (100) by deactivating at least part of the disc drive (10) between fetching of different fetch units;
caching multiple data blocks in a cache memory (12), to avoid fetching a fetch unit to obtain a data block from that fetch unit when that data block is stored in cache memory (12);
predicting a sequence in which the data blocks will be needed by the program;
minimizing the number of times fetch units have to be fetched from disc (100), by selecting at least a first data block for non-retention dependent on a cache status and expected time that a second data block in a same fetch unit as the first data block will be needed next, so that space in the cache memory (12) is freed by not retaining the first data block if it is predicted that the first data block will be fetched when the second data block is predicted to be fetched, before the next use of the first data block.
